(19) United States
(12) Patent Application Publication
(10) Pub. No.: US 2022/0396640 A1
(43) Pub. Date: Dec. 15, 2022

(54) METHOD FOR PREPARING CHITOSAN SUCCINATE HYDROGEL

(71) Applicant: UNIVERSITY-INDUSTRY COOPERATION GROUP OF KYUNG HEE UNIVERSITY, Yongin-si (KR)

(72) Inventors: Il Keun KWON, Seoul (KR); Jae Seo LEE, Seoul (KR); Ha Ram NAH, Goyang-si (KR); Dong Nyoung HEO, Seoul (KR); Ho Jin MOON, Seoul (KR)

(21) Appl. No.: 17/773,028

(22) PCT Filed: Oct. 29, 2020
(86) PCT No.: PCT/KR2020/014908

§ 371 Date: Apr. 28, 2022

(30) Foreign Application Priority Data
Oct. 31, 2019 (KR) 10-2019-0138127

(51) Int. Cl. C08B 37/08; C08J 3/075; C08L 5/08

(52) U.S. Cl. CPC C08B 37/003; C08J 3/075; C08L 5/08; C08L 2203/02; C08J 2305/08

(57) ABSTRACT

The present invention relates to a method for preparing a chitosan succinate having excellent solubility and biocompatibility, and to a succinylated chitosan prepared thereby. The method for preparing a chitosan succinate according to the present invention can prepare a chitosan-based bio-substance having excellent hydrophilicity, cell proliferation rate, cell affinity, and cell proliferation performance through a simple process, thereby having excellent usability in vivo.

### TECHNICAL FIELD

The present invention relates to a method for preparing a succinylated chitosan hydrogel having excellent solubility and biocompatibility, and a succinylated chitosan hydrogel prepared thereby.

### BACKGROUND ART

Chitosan is a kind of aminopolysaccaride obtained by the deacetylation of chitin existing in nature, such as crab and shrimp shells, cuttlefish bone, mold, mushroom mycelium, and microbial cell walls. Chitosan is non-toxic, biodegradable, and exhibits excellent bioaffinity. As it was known as a substance having physiological effects, it also has been applied for medicinal purposes since the 1990s. Thus, chitosan has been used to develop wound-healing agents, artificial skin, anticoagulants, immune enhancers, antimicrobial agents, antioxidants, and the like.

However, chitosan used in the related art has an acetylamino group containing an intermolecular hydrogen bond in the molecule, and thus has problems in that it is difficult to apply to industrial fields because it is not easily dissolved in water and an organic solvent. Chitosan soluble in water includes low-molecular-weight chitosan or chitooligosaccharides. To prepare such water-soluble chitosan, chitin is deacetylated to prepare chitosan dissolved in an acidic aqueous solution such as acetic acid, thereby making the chitosan commercially available. However, the chitosan thus prepared has a problem in that the cells may be severely damaged by the residual acid when it is used in vivo.

In this regard, Korean Patent No. 10-1429455 discloses a method for preparing chitosan, which includes adding metal ions to insoluble chitosan to form a self-synthesized body. However, the chitosan thus prepared also has a drawback in that, because it is not suitable for direct use in vivo due to its low solubility in water, it has low suitability for in vivo use when it is used to prepare a hydrogel.

### DISCLOSURE

### Technical Problem

Therefore, in order to solve the above problems, the present technology is directed to providing a method for preparing a succinylated chitosan hydrogel by binding succinic acid to collagen through a simple process to prepare succinylated chitosan having improved hydrophilicity and suitability for in vivo use, which may be then used as a biomaterial, and a succinylated chitosan hydrogel prepared thereby.

### Technical Solution

To achieve the objects of the present technology as described above, according to an aspect of the present technology, there is provided a method for preparing a succinylated chitosan hydrogel, which includes: dissolving and stirring chitosan in a weak acid to prepare a chitosan solution; centrifuging and freeze-drying the chitosan solution to obtain chitosan acetate; dissolving the obtained chitosan acetate in deionized water; adding succinic anhydride to the dissolved product at room temperature to prepare a mixture; adding NaOH to the mixture to adjust the pH of the mixture to pH 7 to 8 and react the mixture while stirring; dialyzing the reaction product and freeze-drying the dialyzed solution to prepare succinylated chitosan; and adding glucose-6-phosphate dissolved in deionized water to the deionized water, in which the succinylated chitosan is dissolved, and stirring the resulting mixture.

According to another aspect of the present technology, there is provided a succinylated chitosan hydrogel prepared by the method.

### Advantageous Effects

A method for preparing a succinylated chitosan hydrogel according to the present invention can prepare a chitosan-based biomaterial, which has excellent hydrophilicity, cell proliferation rate, cell affinity, and cell proliferation performance and thus exhibits excellent suitability for in vivo use, through a simple process.

### DESCRIPTION OF DRAWINGS

FIG. 1 is a schematic diagram showing a process for preparing succinylated chitosan according to the present technology.

FIG. 2 shows the results of measuring the proton nuclear magnetic resonance (¹H NMR) spectrum of succinylated chitosan according to the present technology.

FIG. 3 shows the fluorescence emission spectrum of the succinylated chitosan according to the present technology.

FIG. 4 shows the UV-VIS absorption spectrum of the succinylated chitosan according to the present technology.

FIG. 5 shows the results of measuring surface distribution charges of the succinylated chitosan according to the present technology.

FIG. 6 shows the results of thermogravimetric analysis (TGA) of the succinylated chitosan according to the present technology.

FIG. 7 shows the results of measuring the chemical state of a surface of the succinylated chitosan according to the present technology using a Fourier transform infrared spectrometer.

FIG. 8 shows the results of evaluating the characteristics of the succinylated chitosan according to the present technology using X-ray photoelectron spectroscopy.

FIG. 9 shows the rheometer experiment results of the succinylated chitosan hydrogel according to the present technology.

FIG. 10 shows the test results of evaluating the biocompatibility of the succinylated chitosan hydrogel according to the present technology.

FIG. 11 shows the test results of measuring the alkaline phosphatase activity of the succinylated chitosan hydrogel according to the present technology.

### BEST MODE

According to one aspect of the present technology, there is provided a method of preparing a succinylated chitosan hydrogel, which includes: (a) dissolving and stirring chitosan in a weak acid to prepare a chitosan solution; (b) centrifuging and freeze-drying the chitosan solution to obtain chitosan acetate; (c) dissolving the obtained chitosan acetate in deionized water; (d) adding succinic anhydride to the dissolved product at room temperature to prepare a mixture; (e) adding NaHCO₃ to the mixture to adjust the pH of the mixture to pH 7 to 8 and react the mixture while stirring; (f) dialyzing the reaction product and freeze-drying the dialyzed solution to prepare succinylated chitosan; and (g) adding glucose-6-phosphate dissolved in deionized water to the deionized water, in which the succinylated chitosan is dissolved, and stirring the resulting mixture.

The weak acid may be an acid with pH 3 to 6, preferably acetic acid.

The dialysis is preferably performed using a dialysis tube with a molecular weight cut-off of 3,000 to 3,500 Da in consideration of the size of the succinylated chitosan to be prepared.

According to another aspect of the present invention, there is provided a succinylated chitosan hydrogel prepared by the method. The succinylated chitosan hydrogel prepared according to the present invention has excellent cell evolutionary potential and thermal stability, and exhibits extraordinary cell proliferation and osteogenic differentiation performance upon in vivo implantation.

Hereinafter, the configurations and actions of examples of the present invention will be described in detail with reference to the drawings.

### EXAMPLE 1

### Materials

Chitosan (MW: 50,000 to 190,000), 4-dimethylaminopyridine (DMAP; >98%), 6-phosphate sodium salt, and succinic anhydride (SA; >99%) were purchased from Sigma Aldrich Co., Ltd. (USA) and used.

Acetic acid was purchased from Junsei Chemical Co., Ltd. (Japan). Deionized water (DW) was prepared using an ultrapure water system (Puris-Ro800, Bio Lab Tech., Korea). Human adipose tissue-derived MSCs (CEFOgro™ ADMSCs), a human adipose tissue-derived MSC growth medium, and supplements (10% FBS, 0.02% penicillin and streptomycin) were purchased from CEFO Co., Ltd. 48-well cell culture plates and cell culture dishes (100 mm×20 mm) were purchased from Corning Inc. (USA). EZ-Cytox (an enhanced cell viability assay kit) was purchased from Dogen (Korea). All reagents and solvents were used as received without further purification.

### EXAMPLE 2

### Preparation of Succinylated Chitosan (CTS-SA)

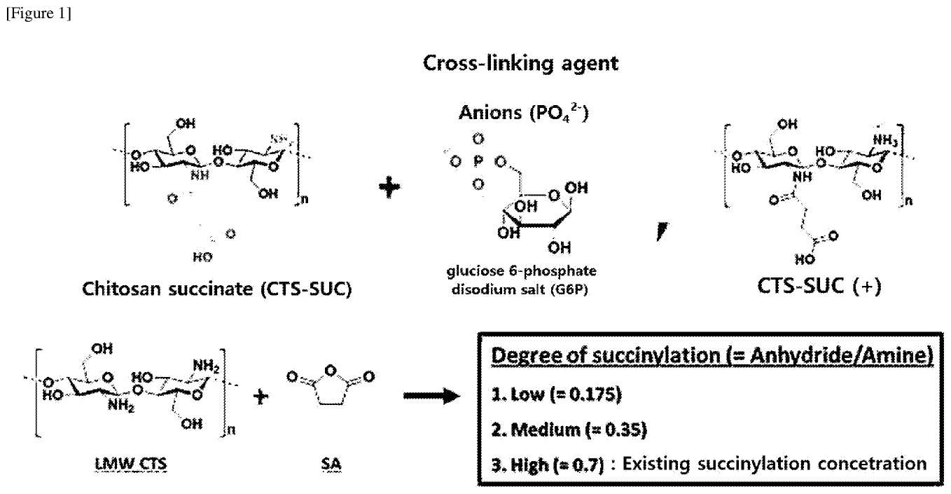

FIG. 1 is a schematic diagram showing a process for preparing succinylated chitosan according to the present invention.

First, 3,000 mg of chitosan was dissolved in 0.1 M acetic acid at a concentration of 1%, and stirred overnight. The chitosan solution was centrifuged at 3,500 rpm for 20 minutes to collect a clear supernatant, and the clear supernatant was freeze-dried to obtain chitosan in the form of an acetate salt (chitosan acetate). 200 mg of the obtained chitosan acetate was dissolved in 30 mL of deionized water. After the chitosan acetate was dissolved for an hour, succinic anhydride was added to the chitosan solution at room temperature.

The succinic anhydride was variously added so that a molar ratio of an amine of chitosan to the succinic anhydride was 1:0.35, 1:0.5, and 1:0.7, and then stirred for 2 hours. For example, when 140 mg of the succinic anhydride was used, 200 mg of chitosan was used so that the molar ratio of the amine group to the succinic anhydride corresponded to a molar ratio of 0.7. Samples in which the succinic anhydride was added so that the molar ratio of the amine group to the succinic anhydride was 1:0.35, 1:0.5, and 1:0.7 were named “CTS-SA70,” “CTS-SA140,” and “CTS-SA280.”

The pH of the mixture was adjusted to pH 7 to 8 by adding 1 N NaOH to the mixture at room temperature. The mixture was reacted overnight, and the reaction mixture was then dialyzed against deionized water for 3 days using a 3,500 Da dialysis tube to prepare succinylated chitosan (CTS-SA). The prepared succinylated chitosan (CTS-SA) was freeze-dried, and stored at −70° C.

### EXAMPLE 3

### Evaluation of Characteristics of Succinvlated Chitosan (CTS-SA)

3-1. NMR Measurement

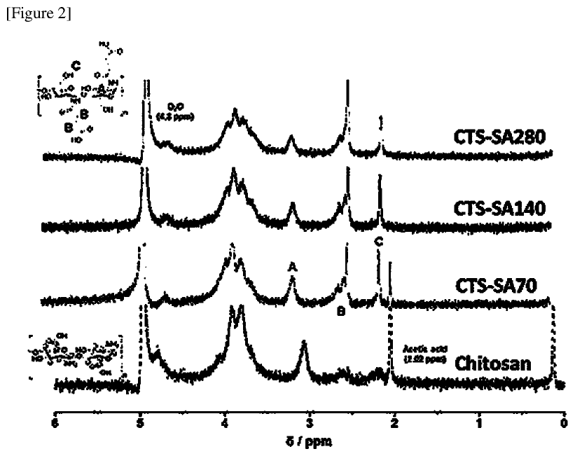

The proton nuclear magnetic resonance CH NMR) spectra of the samples prepared in Example 2 were measured (Bruker Avance 400, Bruker Corporation, USA). Each of the samples prepared in Example 2 was dissolved in 1% D₂O. A pure chitosan solution was used as the control. Chitosan was dissolved in 1% acetic acid, and then measured. The measurement results are shown in FIG. 2.

As shown in FIG. 2, it was confirmed from the measurement results (for example, from the peaks of A, B, and C) that an amine group of chitosan was bound to a carboxyl group of the succinic anhydride to successfully synthesize succinylated chitosan (CTS-SA).

3-2. UV-VIS Measurement

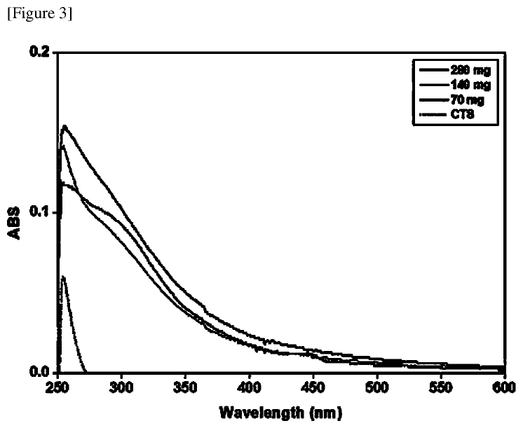

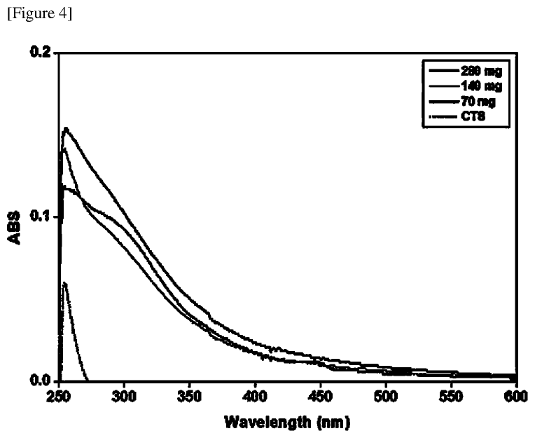

The UV-VIS spectra of the samples prepared in Example 2 were measured. To check the conjugation of chitosan with the succinic anhydride, the fluorescence spectra were collected in a wavelength range of 320 to 400 nm after excitation at 280 nm, and a slit width for excitation and emission was 5 nm, and the UV-Vis spectra were measured by Shimadzu UV-1650PC using a 1 cm-wide quartz cuvette under the conditions of a 10 mM phosphate buffer (pH 7.4). The measurement results are shown in FIGS. 3 and 4.

FIG. 3 shows the fluorescence emission spectra of the samples of Example 2 at different concentrations. An absorption edge was observed at 360 nm. This indicates that succinylation was highly achieved. Especially among the samples, CTS-SA280 exhibited high absorbance, indicating that an absorbance value of chitosan increased due to succinylation. From such results, it can be seen that the succinylated chitosan (CTS-SA) was successfully synthesized.

FIG. 4 shows the UV-VIS absorption spectra of the samples at different concentrations. As shown in FIG. 4, it was shown that a spectrum pattern of the succinylated chitosan was different from that of pure chitosan (CTS). The absorbance of the succinylated chitosan was clearly observed in a wavelength region of 250 to 300 nm compared to the pure chitosan whose absorbance observed in a wavelength region of 250 to 270 nm. A maximum absorption region (Iₘₐₓ) of pure chitosan was observed at 255 nm. Similarly, the maximum absorption region (Iₘₐₓ) of the succinylated chitosan was observed at 255 nm.

3-3. Measurement of Surface Distribution Charges

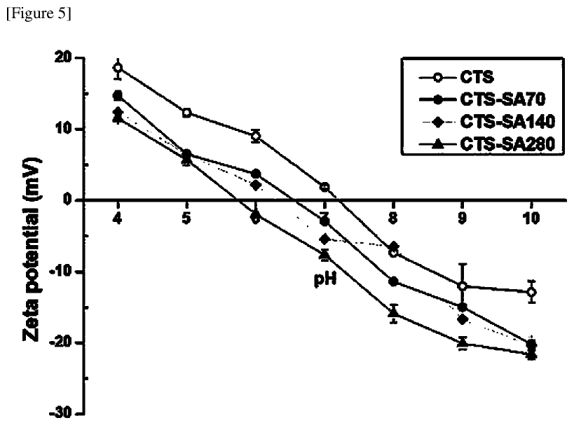

The surface distribution charges of the samples prepared in Example 2 were measured. To determine the distributed charges, succinylated chitosan (CTS-SA) was freeze-dried to measure zeta potentials at different pH values. Before the measurement, the freeze-dried succinylated chitosan was swelled overnight in deionized water, and finely pulverized by sonication, and swelled in deionized water. Approximately 1 mg of a sample was taken, and diluted with 1 mL of deionized water, and the diluted sample was injected into a flow cell. The pH of the solution was titrated to pH 4 to 10 using NaOH and HCl. The surface distribution charges were measured using Malvern Instruments Zetasizer Nano S 90 (ZEN1690, UK). All the values were measured at a temperature of 25° C. in triplicate. The results are shown in FIG. 5.

In general, chitosan is known to have an amine group. It is known that the amine group is easily dissolved at high pH values because it is positively charged. However, as shown in FIG. 5, it can be seen that the pH of the succinylated chitosan (CTS-SA) was lowered because the succinylated chitosan (CTS-SA) is further negatively charged as succinylation proceeds. This consequently indicates that the amine group of chitosan was easily succinylated.

3-4. Thermogravimetric Analysis

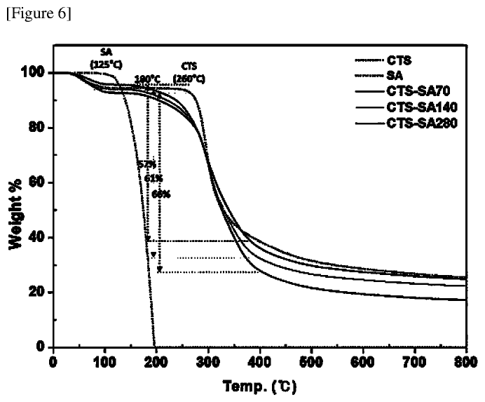

Thermogravimetric analyses (TGA) of the samples prepared in Example 2 were performed. The TGA measurements were performed using TGA Instruments 2960 SDT V3.0F. The succinylated chitosan (CTS-SA) was freeze-dried, 2 to 6 mg portions were taken, and then put into a platinum pan in a furnace. The samples were heated from 10° C. to 800° C. at a heating rate of 10° C./min under nitrogen flow conditions. The results are shown in FIG. 6. TGA was performed to check the synthesis and thermal stability of the succinylated chitosan (CTS-SA).

As shown in FIG. 6, it was shown that the loss of water mostly occurred due to evaporation at high temperature, and thus the succinylated chitosan (CTS-SA) according to the present invention lost approximately 10% of its initial weight at approximately 100° C. After the first curve, a sharp weight loss of the succinic anhydride was observed at 180° C. because a carboxylic acid of the succinic anhydride formed an amide bond with an amine of chitosan. The succinylated chitosan exhibited higher thermal stability than the succinic anhydride. Also, it was confirmed that the thermal stability of the CTS-SA280 was higher because the CTS-SA280 was degraded at a higher temperature than the CTS-SA70.

In the second curve, as succinylation increased, the weight of the succinylated chitosan was reduced to approximately 57%, 61%, and 66% relative to the initial weight of the succinylated chitosan. Based on these results, it can be seen that the amine group of chitosan was successfully covalently bound to the carboxyl group of succinic acid.

3-5. Infrared Spectrometric Measurement

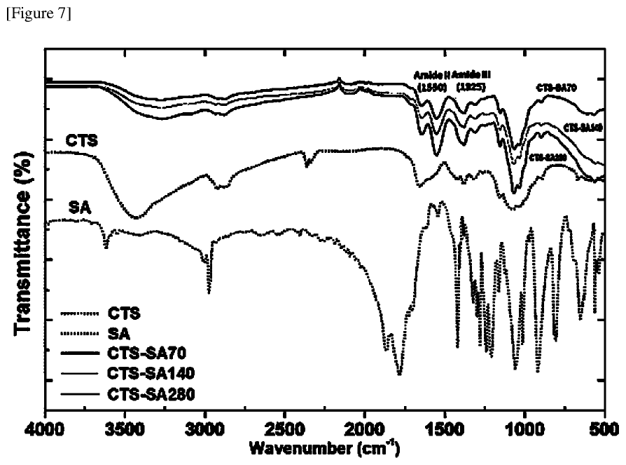

The infrared spectroscopic characteristics of the samples prepared in Example 2 were evaluated. The spectra of the samples were measured using an infrared spectrometer (FT-IR, Thermo Scientific Nicolet 380 spectrometer) using a KBr Pellet technique in which the samples were scanned in a frequency range of 500 to 4,000 cm⁻¹. FIG. 7 shows the results of measuring the chemical state of a surface of the succinylated chitosan (CTS-SA) according to the present invention using a Fourier transform infrared spectrometer.

The peak at 1,550 cm⁻¹ represents the N—H bonding of amide II. The peak intensity of the N—H bond of amide II increases with a degree of succinylation. Also, it can be seen from the peak at 1,325 cm⁻¹ that there was an amide bond III due to the bonding of the succinic anhydride to the amine group of chitosan. It was found that the peak intensity was somewhat different between the types of succinylated chitosan. However, based on the results, it can be seen that succinylation selectively occurred due to the amide reaction between the amine group of chitosan and the carboxyl group of the succinic anhydride.

3-6. X-Ray Photoelectron Spectroscopy

The characteristics of the samples prepared in Example 2 were evaluated using X-ray photoelectron spectroscopy (XPS, Thermo Electron Manufacturing Ltd., the United Kingdom). The succinylated chitosan (CTS-SA) was freeze-dried, and the surface chemical properties of the succinylated chitosan (CTS-SA) were evaluated using K-Alpha equipment (Thermo Electron, UK). The measurements were performed in a measuring range of 0 eV to 1,300 eV.

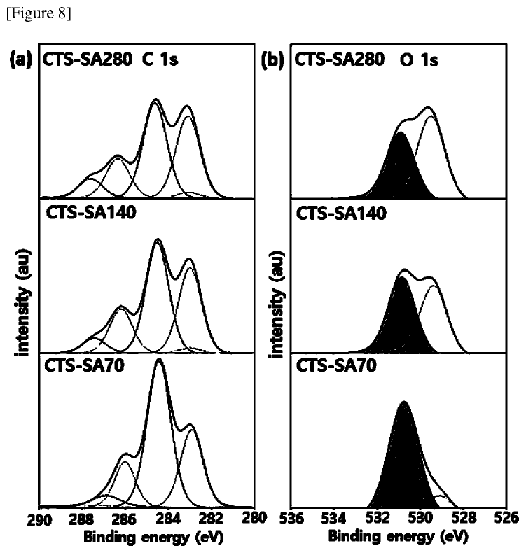

The binding energy was calibrated at C 1 s=284.8 eV and O 1 s=530.0 eV. The measurement results are shown in Table 1 below and FIG. 8.

TABLE 1

| | | CTS | | SA | | CTS-SA70 | | CTS-SA140 | | CTS-SA280 | |
|---|---|---|---|---|---|---|---|---|---|---|---|
| Atom | Deconvolution | Peak BE | Atomic % | Peak BE | Atomic % | Peak BE | Atomic % | Peak BE | Atomic % | Peak BE | Atomic % |
| C | C—C | 282.99 | 34.97 | 283.05 | 30.15 | 282.91 | 16.72 | 283 | 19.45 | 283.1 | 19.72 |
| | C—N | 283.82 | 6.5 | 284.46 | 8.19 | 281.33 | 0.17 | 283 | 1.31 | 283.06 | 1.56 |
| | C—O | 284.66 | 17.26 | 286.18 | 2.65 | 282.91 | 32.95 | 284.51 | 25.14 | 284.61 | 22.72 |
| | C═O | 286.13 | 5.87 | 287.31 | 8.85 | 286.01 | 8.8 | 286.19 | 9.99 | 286.35 | 9.37 |
| | O═C—N | 287.12 | 2.18 | 287.31 | 0.65 | 286.88 | 2.83 | 283 | 3.31 | 287.61 | 4.61 |
| N | C—N—C | 397.68 | 4.00 | 397.07 | 0.04 | 397.56 | 4.31 | 397.53 | 4.25 | 397.69 | 3.35 |
| | O═C—N | 398.69 | 0.27 | 397.83 | 0.54 | 399.65 | 1.75 | 397.53 | 1.05 | 397.66 | 0.86 |
| | N—H | 399.95 | 0.66 | 399.67 | 1.69 | 402.13 | 0.06 | 399.7 | 0.38 | 399.63 | 0.78 |
| O | C═O | 529.52 | 6.02 | 530.08 | 9.32 | 529.13 | 4.47 | 539.39 | 16.8 | 529.5 | 20.79 |
| | O—H | 530.77 | 22.26 | 530.34 | 37.93 | 530.77 | 27.95 | 530.85 | 18.31 | 530.92 | 16.25 |

FIG. 8A shows a C is spectrum representing the degree of succinylation of the succinylated chitosan. The C 1 s spectrum of the succinylated chitosan is composed of five subpeaks corresponding to C—C (282.99 eV), C—N (283.82 eV), C—O (284.66 eV), C═O (286.13 eV), and O═C—N (287.12 eV) bonds. In particular, it was shown that the C/N atomic % of CTS-SA280 decreased compared to those of CTS-SA70 and CTS-SA140. This mostly results from the formation of a C—N bond.

Also, FIG. 8B shows an O 1 s spectrum representing the degree of succinylation of the succinylated chitosan. The O 1 s spectrum of the succinylated chitosan is composed of two subpeaks corresponding to C═O (529.52 eV) and O—H (530.77 eV) bonds. It was shown that the oxygen (O) atomic % of the CTS-SA280 increased due to O—H bonding.

Based on the results, it can be seen that oxygen (O) atoms increased as much as the degree of succinylation. As a result, the hydrophilicity of the succinylated chitosan also increased.

### EXAMPLE 4

### Preparation of Succinylated Chitosan Hydrogel

Each type of succinylated chitosan (CTS-SA70, CTS-SA140, and CTS-SA280) prepared in Example 2 was used to prepare a succinylated chitosan hydrogel (an SC hydrogel).

Each type of succinylated chitosan (CTS-SA70, CTS-SA140, and CTS-SA280) was dissolved in deionized water. Separately, glucose-6-phosphate (G6P) was dissolved in deionized water, and stirred overnight at room temperature to prepare 2 mg/uL of a G6P solution. Thereafter, the G6P solution was slowly stirred until the G6P solution was completely dispersed to obtain a viscous solution. The G6P solution was added to the succinylated chitosan solution at a volume ratio of 2:1 (succinylated chitosan solution:G6P solution), and the resulting mixture was stirred until the mixture become homogeneous.

The mixture was polymerized by diffusion of G6P to prepare a succinylated chitosan hydrogel (an SC hydrogel).

The prepared succinylated chitosan hydrogel was prepared into a 1 mm-thick film, which was then shaped into discs having a diameter of 8 mm using a biopsy punch.

### EXAMPLE 5

### Evaluation of Characteristics of succinylated Chitosan Hydrogel

5-1. Rheometer Experiment

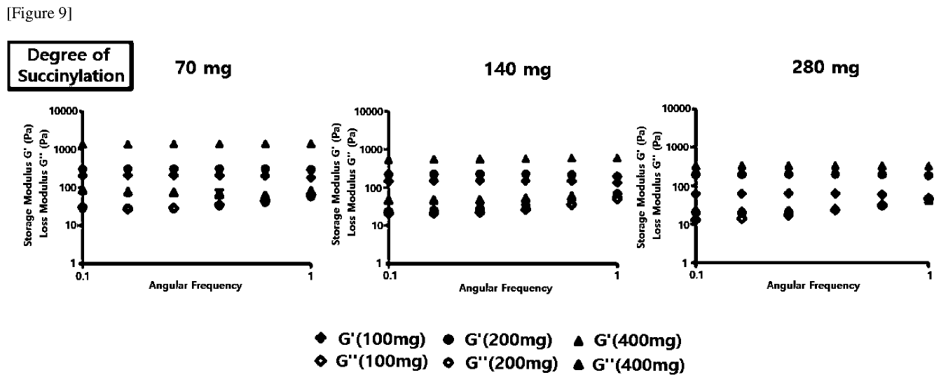

A rheometer experiment was performed on the chitosan hydrogel (an SC hydrogel) of the present invention prepared in Example 4. FIG. 9 shows the rheometer experiment results of the succinylated chitosan hydrogel (an SC hydrogel) according to the present invention.

A rheometer experiment was performed at room temperature (25° C.) using a rotating rheometer with parallel plates in a vibration mode (Anton Paar, Austria). The frequency-dependent viscoelastic behavior of the chitosan hydrogel (an SC hydrogel) prepared in the form of a disc was measured using a rotating rheometer with a plate-plate geometry having a diameter of 8 mm and a gap of 1 mm The storage modulus (G′) and loss modulus (G″) values of each sample were calculated using the following Equation 1, and a frequency sweep was performed at a constant strain of 1% over the range of 0.1 to 10 Hz.

$${G}^{′} = \frac{{σ}_{0}}{{ε}_{0}} cos δ , {G}^{″} = \frac{{σ}_{0}}{{ε}_{0}} sin δ \qquad [ Equation 1 ]$$

As a result, as shown in FIG. 9, it was shown that the storage modulus (G′) increased from 60 Pa to 1,000 Pa depending on the degree of succinylation as the concentration of G6P increased from 100 mg to 400 mg when the succinylated chitosan was added at a concentration of 2.5%.

The storage moduli (G′) of CTS-SA70 (70 mg), CTS-SA140 (140 mg), and CTS-SA280 (280 mg) were measured to be 61±4.818, 146±0.118, and 205±0.011 Pa, respectively, at the minimum concentration (100 mg) of G6P. Also, the loss moduli (G″) of all the samples were measured in a similar manner The G′ and G″ values decreased due to succinylation, whereas the mechanical strength was higher as succinylation decreased.

5-2. Evaluation of Biocompatibility

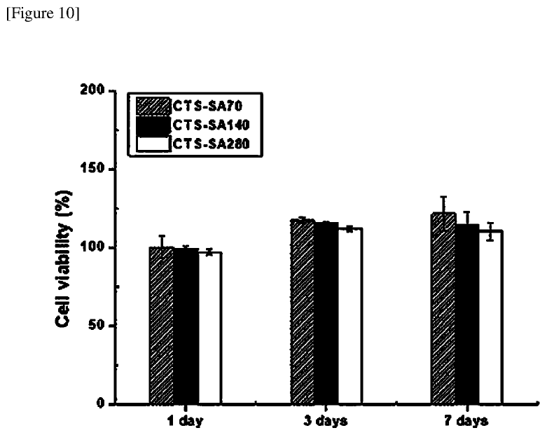

An evaluation test was performed for the biocompatibility of the chitosan hydrogel (an SC hydrogel) of the present invention prepared in Example 4. For biocompatibility evaluation, human adipose tissue-derived MSC cells (hADSCs) were encapsulated in a 96-well tissue culture plate at a density of 2×10⁴ cells per well. The hADSCs were grown in a human adipose tissue-derived MSC growth medium with supplements (10% FBS, 0.02% penicillin and streptomycin). In all the experiments, the hydrogel was washed with sterile phosphate buffered saline (PBS), and the culture medium was replaced with a fresh medium every 2 days. Each of the plates was incubated at 37° C. for different periods of 1, 3 and 7 days under a 5% CO₂ atmosphere, and 100 μL of a cell counting kit (CCK) solution was then added to each well of the 96-well tissue culture plate, and the plate was incubated for 2 hours. Absorbance was measured suing a Benchmark Plus microplate spectrophotometer (Bio-Rad, BR170-6930). The results are shown in FIG. 10.

As shown in FIG. 10, a hydrogel was prepared according to the concentration of the succinylated chitosan, and the cytotoxicity of the succinylated chitosan was evaluated. As a result, it can be seen that the cell proliferation rate was highest in the CTS-SA70 having the lowest degree of succinylation. This indicates that the cytoplasm is negatively charged, but the inside part of the hydrogel is also negatively charged because the number of carboxyl groups increases with an increasing degree of succinylation. Therefore, it is judged that the cell affinity was lowered accordingly.

5-3. Evaluation of Alkaline Phosphatase (ALP) Activity

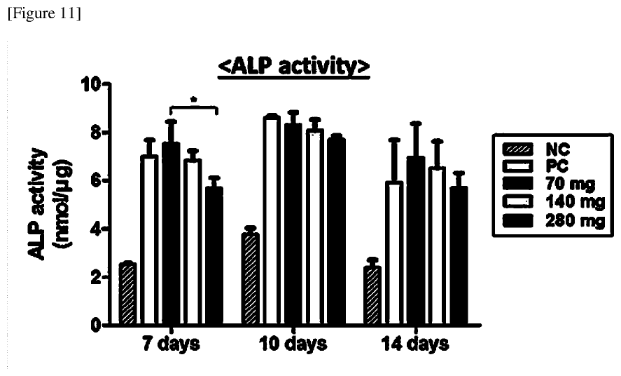

An alkaline phosphatase (ALP) activity evaluation test was performed on the chitosan hydrogel (an SC hydrogel) of the present invention prepared in Example 4. Human adipose tissue-derived MSC cells (hADSCs) were encapsulated in a 48-well tissue culture plate at a density of 2×10⁴ cells per well, and cultured in a growth medium for a day, and the medium was then replaced with an osteogenic medium. The cell cultures were collected on days 5, 10, and 15, and used as samples. For the analysis of ALP activity, the cultured hADSCs were washed with DPBS, and dissolved in a 3X RIPA buffer at 4° C. for an hour. The dissolved hADSCs were centrifuged at 10,000 rpm for 10 minutes, and the supernatant was reacted with p-nitrophenolphosphate (pNPP; Sigma Aldrich Co., Ltd.) for 30 minutes in a 37° C. incubator. A production amount of p-nitrophenol was measured at a wavelength of 405 nm using an ELISA reader. The results are shown in FIG. 11.

As shown in FIG. 11, the hydrogel was prepared according to the concentration of the succinylated chitosan to check the alkaline phosphatase activity. As a result, it was shown that the osteogenic differentiation rate was highest in the CTS-SA70 having the lowest degree of succinylation. As a result, it can be seen that the chitosan hydrogel (an SC hydrogel) of the present invention might exhibit strength similar to actual bone because the physical properties of the chitosan hydrogel were enhanced with a decreasing degree of succinylation.

While the present technology has been shown and described with reference to certain exemplary embodiments thereof, it will be understood that the exemplary embodiments are not intended to limit the scope of the present technology. Thus, it will be apparent to those skilled in the art that various changes and modifications may be made to the exemplary embodiments without departing from the spirit and scope of the present technology, and the present technology encompasses such changes and modifications.

### INDUSTRIAL APPLICABILITY

According to the present technology, a succinylated chitosan hydrogel having excellent solubility and biocompatibility may be prepared, and thus may be used to develop various biocompatible substances such as bone fillers, drug delivery systems, and the like.

1. A method for preparing a succinylated chitosan hydrogel, comprising:
(a) dissolving and stirring chitosan in a weak acid to prepare a chitosan solution;
(b) centrifuging and freeze-drying the chitosan solution to obtain chitosan acetate;
(c) dissolving the obtained chitosan acetate in deionized water;
(d) adding succinic anhydride to the dissolved product at room temperature to prepare a mixture;
(e) adding NaOH to the mixture to adjust the pH of the mixture to pH 7 to 8 and react the mixture while stirring;
(f) dialyzing the reaction product and freeze-drying the dialyzed solution to prepare succinylated chitosan; and
(g) adding glucose-6-phosphate dissolved in deionized water to the deionized water, in which the succinylated chitosan is dissolved, and stirring the resulting mixture.

2. The method of claim 1, wherein the weak acid is acetic acid.

3. The method of claim 1, wherein the dialysis is performed using a dialysis tube with a molecular weight cut-off of 3,000 to 3,500 Da.

4. A succinylated chitosan hydrogel prepared by the method defined in claim 1.
